(19) United States
(12) Patent Application Publication
(10) Pub. No.: US 2013/0110824 A1
(43) Pub. Date: May 2, 2013

(54) CONFIGURING A CUSTOM SEARCH RANKING MODEL

(71) Applicants: Pedro Dantas DeRose, Snoqualmie, WA (US); Vishwa Vinay, Chesterton (GB); Dmitriy Meyerzon, Bellevue, WA (US)

(72) Inventors: Pedro Dantas DeRose, Snoqualmie, WA (US); Vishwa Vinay, Chesterton (GB); Dmitriy Meyerzon, Bellevue, WA (US)

(73) Assignee: MICROSOFT CORPORATION, Redmond, WA (US)

(21) Appl. No.: 13/286,752

(22) Filed: Nov. 1, 2011

(51) Int. Cl. G06F 17/30

(52) U.S. Cl. 707/723; 707/E17.084

(57) ABSTRACT

A custom search ranking model is configured using a base ranking model that is combined with one or more additional ranking features. A base ranking model that has already been configured and tuned is selected that serves as the base ranking model for a custom search ranking model. The additional ranking feature(s) to combine with the base ranking model may be manually/automatically identified. For example, a feature selection algorithm may be used to automatically identify ranking features that are likely to have a positive impact on results provided by the base search ranking model. A user may also know of the ranking feature(s) that they would like to add to the base ranking model. The custom search ranking model may also be evaluated by automatically creating a set of virtual queries for evaluation.

### BACKGROUND

Search applications use ranking models to determine how data is weighed and results are ranked. Configuring these ranking models is a difficult task that requires a large amount of time and expertise. For example, creating a ranking model from scratch requires a carefully chosen set of features and a very large number of manual judgments (tens of thousands or more). A sophisticated administrator that is very experienced in search may be able to fine tune the ranking model, but this can be a very difficult process that may not result in the desired behavior.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A custom search ranking model is configured using a base ranking model that is combined with one or more additional ranking features. A base ranking model that has already been configured and tuned is selected that serves as the base ranking model for a custom search ranking model. The additional ranking feature(s) to combine with the base ranking model may be manually/automatically identified. For example, a feature selection algorithm may be used to automatically identify ranking features that are likely to have a positive impact on results provided by the base search ranking model. A user may also know of the ranking feature(s) that they would like to add to the base ranking model. The custom search ranking model that includes the additional ranking features is trained using a relatively smaller number of relevance judgments as compared to creating a ranking model from scratch. The custom search ranking model may also be evaluated by automatically creating a set of virtual queries for evaluation. The evaluation of the virtual queries helps to provide the user configuring the search model more confidence, which can reduce the number of judgments used in evaluation of the custom search ranking model.

### BRIEF DESCRIPTION OF THE DRAWINGS

FIG. 1 illustrates an exemplary computing device;

FIG. 2 illustrates an exemplary system for configuring a custom search ranking model;

FIG. 3 illustrates a process for creating a custom search ranking model by combining a base model with at least one additional ranking feature;

FIG. 4 shows a process for determining additional ranking feature(s) to add to a base ranking model;

FIG. 5 illustrates a process for evaluating queries and tuning the custom search ranking model; and

FIGS. 6-15 show example user interface displays for configuring a search ranking model.

### DETAILED DESCRIPTION

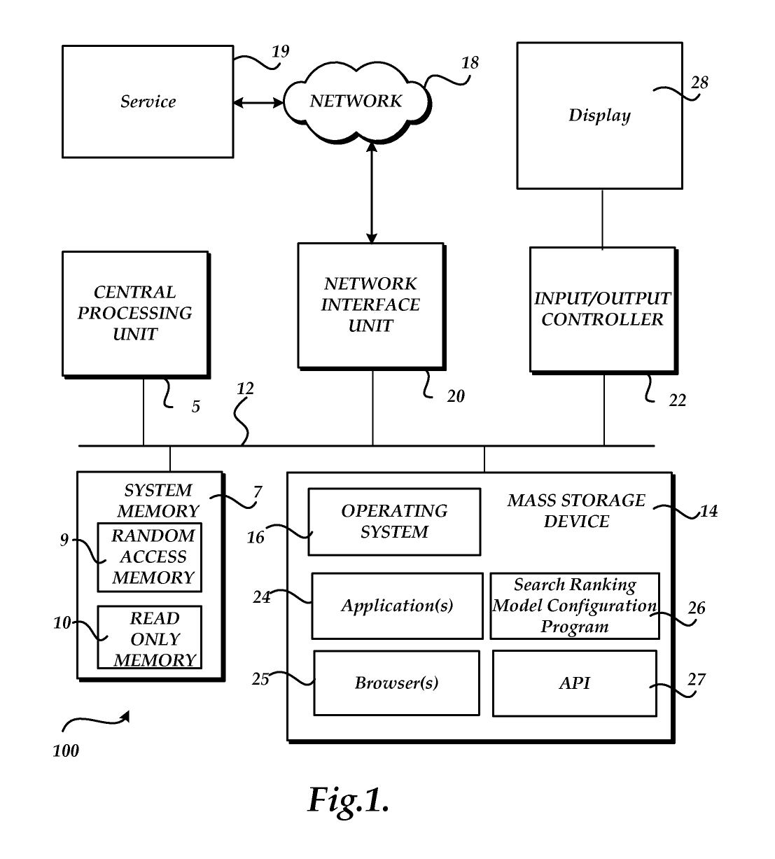

Referring now to the drawings, in which like numerals represent like elements, various embodiments will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer architecture for a computer 100 utilized in the various embodiments will be described. The computer architecture shown in FIG. 1 may be configured as a server computing device, a desktop computing device, a mobile computing device (e.g. smartphone, notebook, tablet . . . ) and includes a central processing unit 5 (“CPU”), a system memory 7, including a random access memory 9 (“RAM”) and a read-only memory (“ROM”) 10, and a system bus 12 that couples the memory to the central processing unit (“CPU”) 5.

A basic input/output system containing the basic routines that help to transfer information between elements within the computer, such as during startup, is stored in the ROM 10. The computer 100 further includes a mass storage device 14 for storing an operating system 16, application(s) 24, and other program modules, such as Web browser 25, and search ranking model configuration program 26 which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, Erasable Programmable Read Only Memory (“EPROM”), Electrically Erasable Programmable Read Only Memory (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

According to various embodiments, computer 100 may operate in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, such as a touch input device. The touch input device may utilize any technology that allows single/multi-touch input to be recognized (touching/non-touching). For example, the technologies may include, but are not limited to: heat, finger pressure, high capture rate cameras, infrared light, optic capture, tuned electromagnetic induction, ultrasonic receivers, transducer microphones, laser rangefinders, shadow capture, and the like. According to an embodiment, the touch input device may be configured to detect near-touches (i.e. within some distance of the touch input device but not physically touching the touch input device). The touch input device may also act as a display 28. The input/output controller 22 may also provide output to one or more display screens, a printer, or other type of output device.

A camera and/or some other sensing device may be operative to record one or more users and capture motions and/or gestures made by users of a computing device. Sensing device may be further operative to capture spoken words, such as by a microphone and/or capture other inputs from a user such as by a keyboard and/or mouse (not pictured). The sensing device may comprise any motion detection device capable of detecting the movement of a user. For example, a camera may comprise a MICROSOFT KINECT® motion capture device comprising a plurality of cameras and a plurality of microphones.

Embodiments of the invention may be practiced via a system-on-a-chip (SOC) where each or many of the components/processes illustrated in the FIGURES may be integrated onto a single integrated circuit. Such a SOC device may include one or more processing units, graphics units, communications units, system virtualization units and various application functionality all of which are integrated (or “burned”) onto the chip substrate as a single integrated circuit. When operating via a SOC, all/some of the functionality, described herein, may be integrated with other components of the computer 100 on the single integrated circuit (chip).

As mentioned briefly above, a number of program modules and data files may be stored in the mass storage device 14 and RAM 9 of the computer 100, including an operating system 16 suitable for controlling the operation of a networked computer, such as the WINDOWS SERVER®, WINDOWS 7® operating systems from MICROSOFT CORPORATION of Redmond, Wash.

The mass storage device 14 and RAM 9 may also store one or more program modules. In particular, the mass storage device 14 and the RAM 9 may store one or more applications 24, such as a search ranking model configuration application 26, productivity applications, and may store one or more Web browsers 25. The Web browser 25 is operative to request, receive, render, and provide interactivity with electronic documents, such as a Web page. According to an embodiment, the Web browser comprises the INTERNET EXPLORER Web browser application program from MICROSOFT CORPORATION.

Search ranking model configuration program 26 is configured to assist in configuration of a custom search ranking model that is created by modifying a base ranking model (e.g. changing weights) or combining a base ranking model with at least one additional ranking feature. Search ranking model configuration program 26 may be a stand-alone application and/or a part of a cloud-based service (e.g. service 19). For example, the functionality of search ranking model configuration program 26 may be a part of a cloud based multi-tenant service that provides resources (e.g. services, data . . . ) to different tenants (e.g. MICROSOFT OFFICE 365, MICROSOFT SHAREPOINT ONLINE). Using the search ranking model configuration application, a custom search ranking model is configured using a base ranking model or combining a base ranking model with one or more additional ranking features. A pre-configured base ranking model that has already been configured and tuned is selected that serves as the base ranking model for a custom search ranking model. Any additional ranking feature(s) to combine with the base ranking model may be manually/automatically identified. For example, a feature selection algorithm may be used to automatically identify features that are likely to have a positive impact on results provided by the base search ranking model. A user may also know of the feature(s) that they would like to add to the base ranking model. The custom search ranking model that includes the additional ranking features is trained using a relatively smaller number of relevance judgments as compared to creating a ranking model from scratch. Care should be taken to provide a sufficient amount of data to the tuning algorithm to avoid overfitting. An evaluation on an independent set of queries may be conducted as well.

The custom search ranking model may also be evaluated by automatically creating a set of virtual queries for evaluation. The evaluation of the virtual queries helps to provide the user configuring the search model more confidence, which can reduce the number of judgments used in evaluation of the custom search ranking model. Additional details regarding the operation of configuration manager 26 and search ranking model configuration application will be provided below.

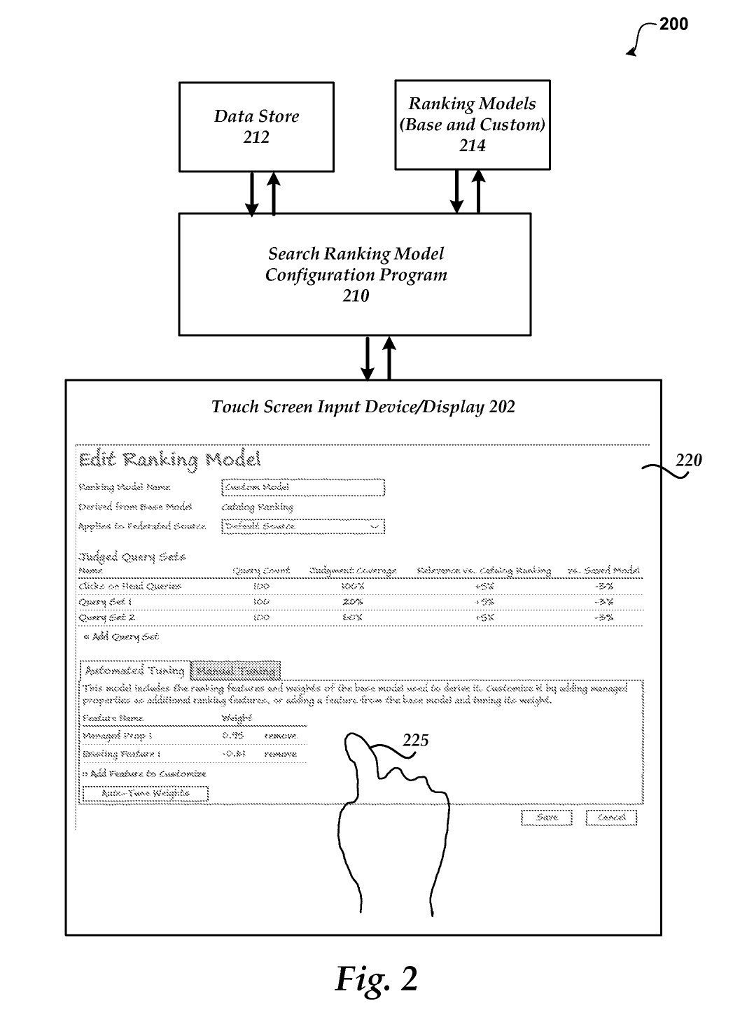

FIG. 2 illustrates an exemplary system for configuring a custom search ranking model. As illustrated, system 200 includes search ranking model configuration program 210, data store 212, ranking models 214 and touch screen input device/display 202.

Search ranking model configuration program 210 is a program that is configured to receive input from a user (e.g. using touch-sensitive input device 202 and/or keyboard input (e.g. a physical keyboard and/or SIP)) for configuring a custom search ranking model.

Touch input system 200 as illustrated comprises a touch screen input device/display 202 that detects when a touch input has been received (e.g. a finger touching or nearly teaching the touch screen). Any type of touch screen may be utilized that detects a user's touch input. For example, the touch screen may include one or more layers of capacitive material that detects the touch input. Other sensors may be used in addition to or in place of the capacitive material. For example, Infrared (IR) sensors may be used. According to an embodiment, the touch screen is configured to detect objects that in contact with or above a touchable surface. Although the term “above” is used in this description, it should be understood that the orientation of the touch panel system is irrelevant. The term “above” is intended to be applicable to all such orientations. The touch screen may be configured to determine locations of where touch input is received (e.g. a starting point, intermediate points and an ending point). Actual contact between the touchable surface and the object may be detected by any suitable means, including, for example, by a vibration sensor or microphone coupled to the touch panel. A non-exhaustive list of examples for sensors to detect contact includes pressure-based mechanisms, micro-machined accelerometers, piezoelectric devices, capacitive sensors, resistive sensors, inductive sensors, laser vibrometers, and LED vibrometers.

As illustrated, touch screen input device/display 202 shows an exemplary UI display for editing and tuning a custom search ranking model. Creating a ranking model from scratch that addresses a large breadth of search scenarios, requires a very carefully chosen set of features and a very large number of manual judgments (tens of thousands or more) that is beyond the resources available to many operations. The search ranking model configuration program 210 is designed to allow a user to create a custom search ranking model by combining a base model with one or more additional ranking features. In many situations, a base ranking model provides an operation with a ranking model that is close to satisfying the search needs for the operation but does not quite produce the desired results.

Configuration program 210 is configured to incorporate a number of additional ranking features with the base ranking model manually and/or automatically. Many times, a user (e.g. a search administrator) may know of a small set of additional ranking features that are important in their domain but that the base ranking model may not give significant weight and/or even consider. These additional ranking features that are not used by the base ranking model are included within a search index (e.g. stored in data store 212) that the search application accesses. For example, the base ranking model may consider 25 of the 35 available ranking features within a search index. For example, the ranking features may include features such as any text field (descriptions) of the items that will be matched with the query, any numeric fields (e.g rating) that will determine the general quality of the item with respect to search, and the like.

Configuration program 210 may also automatically provide suggested ranking features to the user to include with the base ranking model. A feature selection algorithm (such as mutual information or entropy reduction) is used to suggest highly impactful ranking features to the user. This helps keep the number of extra features small, which in turn keeps the number of judgments required for tuning small.

Typically, when creating a ranking model a large number of relevance judgments are created by the user to configure a ranking model. Configuration program 210 may be used to automatically create a set of queries for evaluation and may also create a set of virtual evaluations to assist in judging how well the custom search ranking model is tuned. Configuration program 210 may create a set of virtual evaluations by examining query logs. The most commonly performed queries are determined and then, commonly clicked results for these queries are determined to be positive evaluations, and commonly skipped results are determined to be negative evaluations. This virtual evaluation set assists users who are configuring the custom search ranking model to see how their new ranking model would affect the queries their users perform most frequently. The virtual evaluation may give them more confidence, which can reduce the number of judgments they feel is needed for evaluation.

Configuration program 210 may also automatically generate a set of queries to present to the user for evaluation. For example, the queries that are automatically generated may be based on the popular queries, the performance of queries (e.g. good, poor), and the like. As such, configuration program 210 assists the user in choosing good query sets for tuning the custom search ranking model by leveraging query logs to select a combination of head and tail queries, and/or to select queries where users often do not click any results (i.e., queries where relevance is particularly bad). The user/administrator may also use an existing list of queries (e.g. those that have critical impact on the business) to form the virtual set for evaluation.

The following example is provided for explanatory purposes only, and is not to be considered limiting. In the example, assume that John is creating a search vertical for music files in his MICROSOFT SHAREPOINT deployment. He finds that a base ranking model that is provided with the program does not perform very well on his music files, even when he makes key managed properties searchable, such as artist, title, year, etc. John believes that this is because not enough weight is put on the title and artist properties. Furthermore, though John tracks how often users listen to a song in a managed property, the base ranking model does not take this into account. To address this, John accesses the search ranking model configuration program 210 to create a custom ranking model. John's custom search ranking model places more weight on the title and artist fields, and ranks songs that are listened to often more highly. When John evaluates his new custom search ranking model on a set of test queries, he finds that it performs much better than using only the base ranking model.

When John is configuring a custom ranking model he may look at how query sets are performing on the current version of the custom ranking model as compared to the base mode as compared to a previous version of the model. He may also manually/automatically tune the model, provide evaluations on the queries, generate queries, create queries, receive recommendations for other ranking features that may benefit the search, and the like. (See FIGURES below including exemplary UI screens for configuring the custom search ranking model).

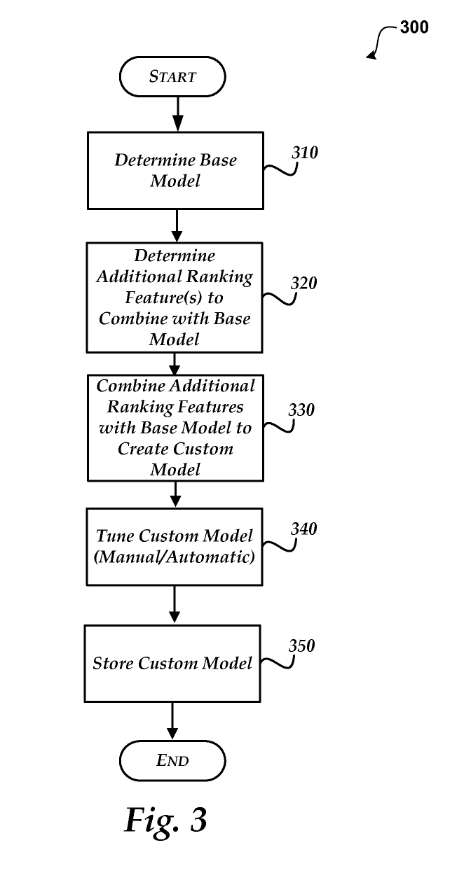

FIGS. 3-5 show an illustrative process for configuring a search ranking model. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof

FIG. 3 illustrates a process for creating a custom search ranking model by combining a base model with at least one additional ranking feature.

After a start operation, the process 300 flows to operation 310, where a base model is determined. The base ranking models are search ranking models that are used in determining how data is weighed and results are ranked. Any number of base ranking models may be available for selection. Generally, these base ranking models are highly tuned search ranking models that has been tuned using tens of thousands of manual evaluations/judgments of queries). According to an embodiment, the user selects the base model from a graphical user interface displayed by the search ranking model configuration program.

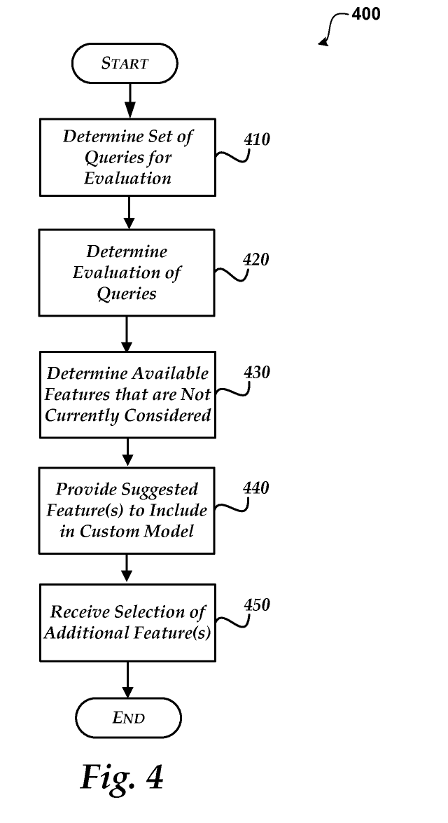

Moving to operation 320, at least one additional ranking feature is determined to be combined with the selected base ranking model. The additional ranking feature(s) may be determined manually/automatically. For example, a user may know of a ranking feature that should be included within the base ranking model that is not currently being considered. The search ranking model configuration application may also automatically generate recommendations of ranking features for a user to add to the base ranking model (See FIG. 4 and related discussion).

Flowing to operation 330, any of the selected additional ranking features are combined with the base ranking model. Instead of creating a completely new search ranking model that requires a large number of evaluations and tuning, a custom search model is created that uses far fewer evaluations when tuning the model.

Transitioning to operation 340, the custom search ranking model is tuned. The tuning may occur automatically/manually. For example, a user may manually adjust weights of the additional ranking feature(s) and/or allow the configuration program to automatically weight the additional ranking feature(s). The base model may be left as is (i.e. no changes) when combining the additional features and/or the base model may be changed.

Moving to operation 350, the custom search ranking model is stored.

The process then moves to an end operation and returns to processing other actions.

FIG. 4 shows a process for determining additional ranking feature(s) to add to a base ranking model.

After a start operation, the process 400 flows to operation 410, where a set of queries is determined for evaluation. The set may be determined manually and/or automatically. For example, a user may manually add some queries for evaluation and the configuration program can automatically generate a set of queries for evaluation. According to an embodiment, the configuration program examines query logs to determine queries to include in the evaluation process (e.g. popular queries, low-performing queries, high-performing queries . . . ).

Moving to operation 420, an evaluation of the queries is determined According to an embodiment, an evaluation typically uses precision @10 accuracy measure, but other metrics can be deployed (NDCG, etc). A user may judge/evaluate all/portion of the queries. Generally, the more queries that are evaluated, the more reliable the tuning of the search ranking model. The configuration program may also generate a virtual set of evaluations by examining query logs. According to an embodiment, the most commonly performed queries are determined and then, commonly clicked results for these queries are determined to be positive evaluations, and commonly skipped results are determined to be negative evaluations. This virtual evaluation set assists users who are configuring the custom search ranking model to see how their new ranking model would affect the queries their users perform most frequently.

Flowing to operation 430, available features that are not currently being considered by the base ranking model are determined For example, a search index may have 50 properties being tracked, but the base ranking model is only considering 35 of the properties.

Transitioning to operation 440, one or more ranking features are suggested to the user to include in the custom search ranking model. According to an embodiment, a feature selection algorithm (such as mutual information or entropy reduction) is used to suggest highly impactful ranking features to the user.

Moving to operation 450, a user selects the additional ranking feature(s) that they would like to combine with the base ranking model. These selected ranking features are added to the custom search ranking model (See Operation 330 in FIG. 3).

The process then moves to an end operation and returns to processing other actions.

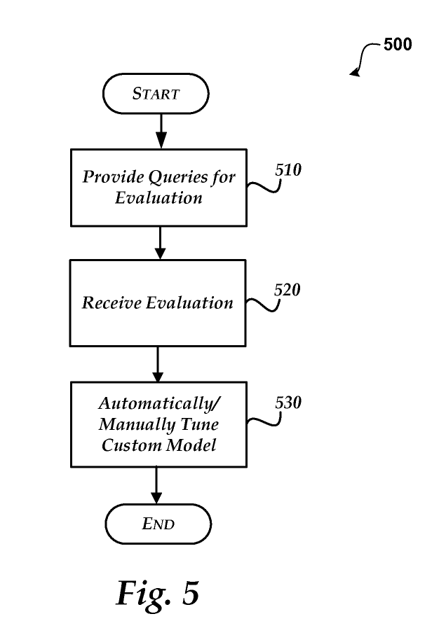

FIG. 5 illustrates a process for evaluating queries and tuning the custom search ranking model.

After a start operation, the process 500 flows to operation 510, where a set of queries is generated and provided to the user for evaluation after being submitted to the custom search engine. The queries may be automatically/manually generated. According to an embodiment, a user may specify different sets of queries that they would like to be automatically generated (e.g. most popular, random queries, poorly performing queries, and the like).

Moving to operation 520, the user supplies the evaluation for at least a portion of the generated queries.

Flowing to operation 530, the custom search ranking model is tuned automatically/manually. For example, the custom search ranking model may be automatically tuned by the system in response to the evaluated queries and/or the user may manually adjust weights within the custom search ranking model and/or in the base ranking model. When the number of parameters to be tuned are small, a simple enumeration of all possible values may be used to identify the best combination. Alternatively, a gradient-based optimization algorithm (e.g. LambdaRank) may be used where the weights in the base and custom model that are to be tuned are considered parameters of the scoring function corresponding to the ranking model, and the other weights are considered as constants.

The process then moves to an end operation and returns to processing other actions.

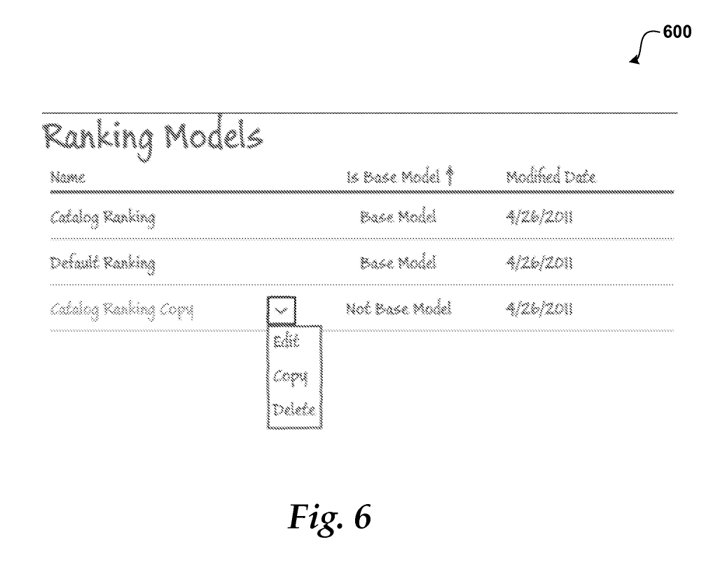

FIG. 6 shows an exemplary ranking models page. As illustrated, display 600 shows a list of available ranking models. Some of the models are base models (e.g. Catalog Ranking and Default Ranking) and a custom model that is based on the base Catalog Ranking Model. According to an embodiment, a set of base models are provided for a user to select. The base models are two-stage linear models that are trained with large labeled query set. According to an embodiment, the base models are not editable. A base model can be copied to create a custom model.

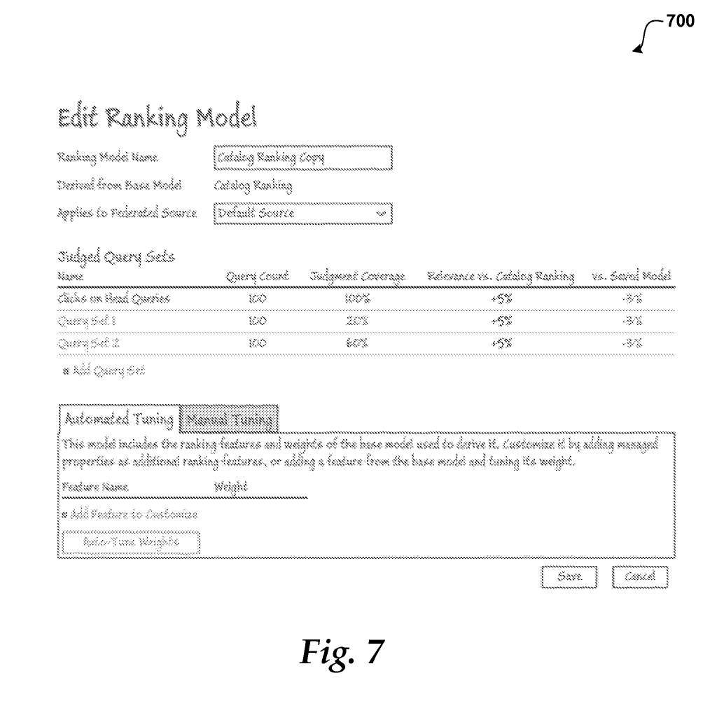

FIG. 7 shows an exemplary edit ranking models page. As illustrated, display 700 shows information about the ranking model, judged query sets, and tuning options.

According to an embodiment, the “Clicks on Head Queries” initially appears. The Clicks on Head Queries is a virtual query comprising head queries from the query log, where good results are those queries having a high click through.

According to an embodiment, a progress indicator is displayed that shows what percentage of the queries have been evaluated. Display 700 also shows the relevance of the custom search ranking model as compared to the base ranking model and a previously save model. According to an embodiment, the colors of the numbers are changed (e.g. better is green, worse is red).

The automated tuning is selected to have the configuration program automatically tune the weights of the custom search ranking model. According to an embodiment, auto-tuning is not available until a predetermined number of queries has been evaluated (e.g. fifty across a number of query sets).

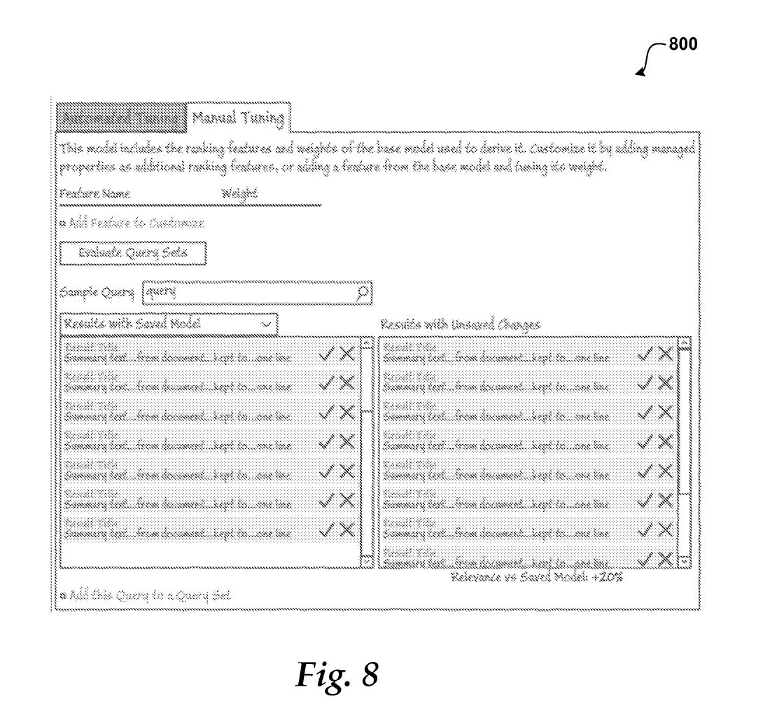

FIG. 8 shows an exemplary manual tuning tab. As illustrated, display 800 shows information about manual tuning Clicking on the check mark or the X to judge, again to remove judgment. The relevance is updated as the user evaluates the queries.

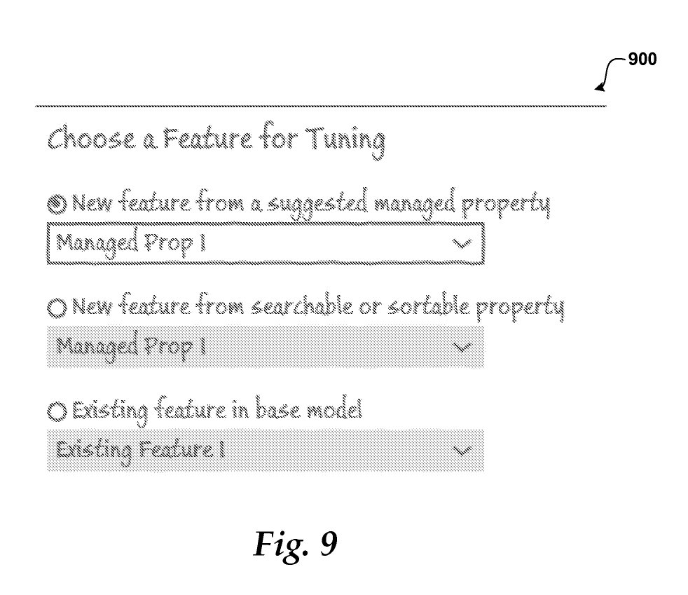

FIG. 9 shows an choose ranking feature dialog. As illustrated, display 900 shows a UI display for choosing an additional ranking feature to combine with the selected base model. As illustrated, the first dropdown is populated with suggested ranking features generated by the configuration program. The second dropdown is populated with all searchable text or sortable numeric properties. The third dropdown is populated with existing features in the base model. Adding an existing feature to the custom model puts it in with the weight of the feature in the base model. This allows a feature that is already included to be differently weighted.

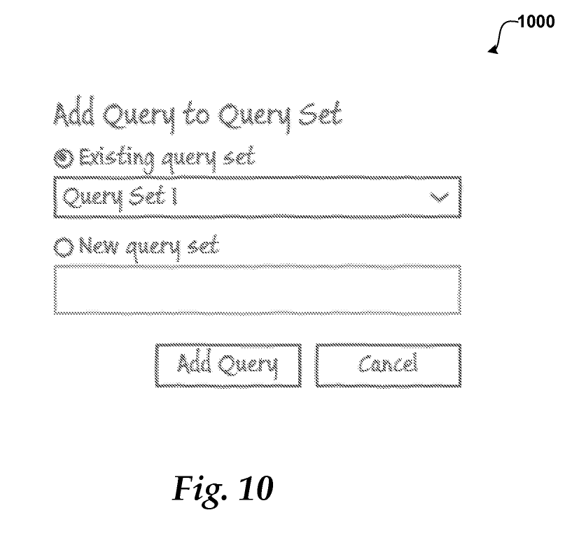

FIG. 10 shows an add query dialog. As illustrated, display 1000 shows a UI display for adding a query to a query set.

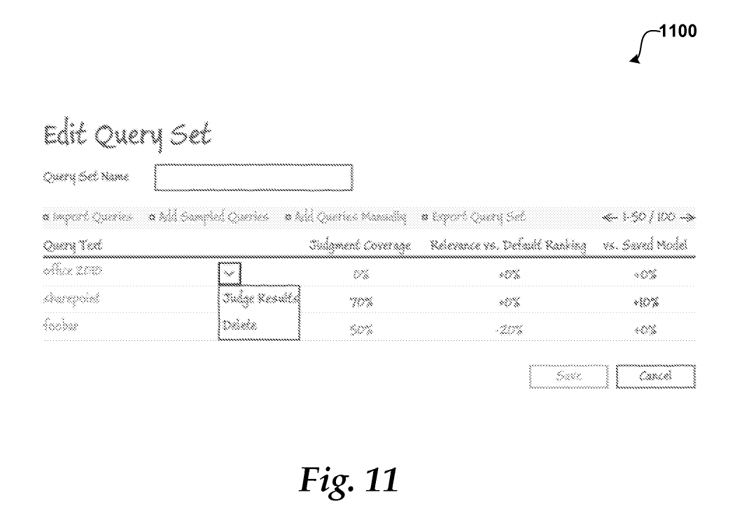

FIG. 11 shows an edit query set dialog. As illustrated, display 1100 shows a UI display for editing a query set.

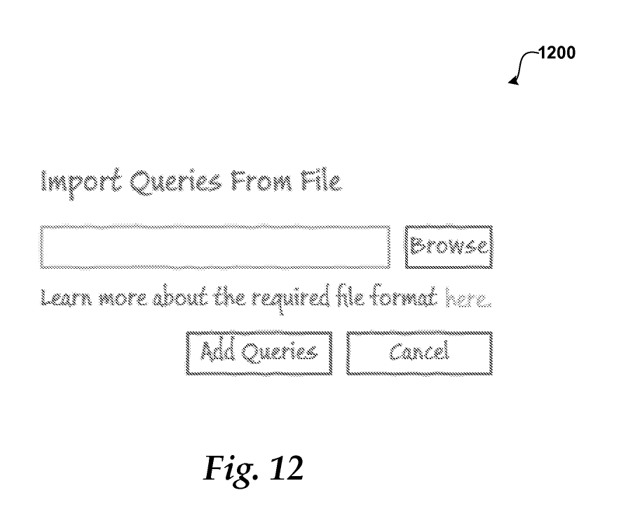

FIG. 12 shows an import queries from file dialog. As illustrated, display 1200 shows a UI display for importing queries from a file.

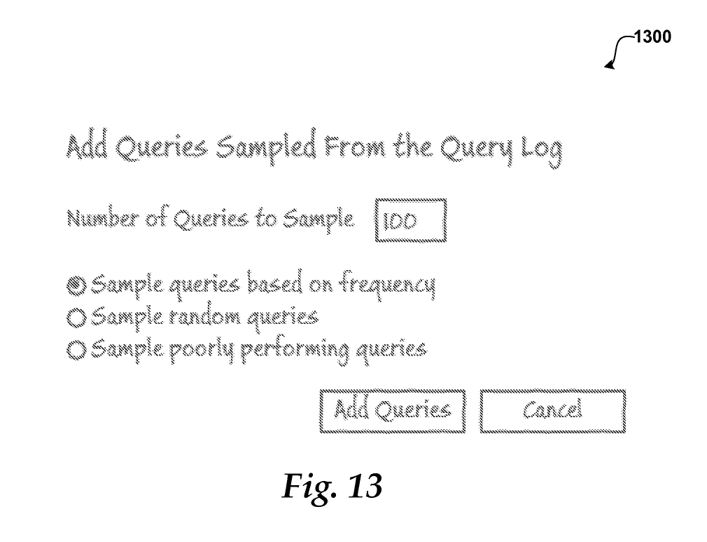

FIG. 13 shows an add sampled queries dialog. As illustrated, display 1300 shows a UI display for adding queries sampled from the query log. As shown, the user may select from queries sampled based on frequency, a set of random queries and a set of poorly performing queries.

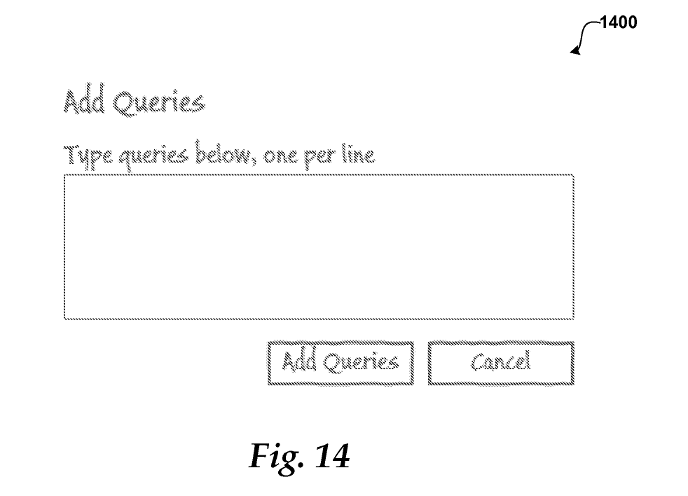

FIG. 14 shows an add query dialog. As illustrated, display 1400 shows a UI display for adding queries.

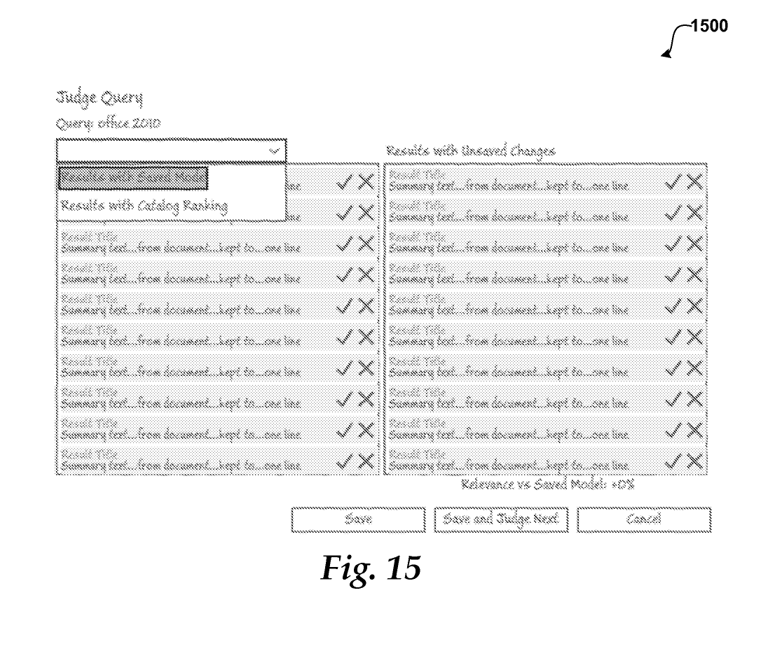

FIG. 15 shows a judge query dialog. As illustrated, display 1500 shows a UI display for judging queries.

As the user adds queries, judges results, and changes the model, the judgment coverage and relevance metrics are updated.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for configuring a search ranking model, comprising:
determining a base ranking model to use as a primary search ranking model;
determining an evaluation of a set of queries based on results provided by the base model;
determining a ranking feature to add to the base ranking model;
combining the ranking feature with the base ranking model to create a custom search ranking model;
tuning the custom search ranking model; and
storing the custom search ranking model.

2. The method of claim 1, wherein the set of queries for determining the evaluation are selected based on a popularity of queries made using the base ranking model.

3. The method of claim 1, wherein determining the ranking feature to add to the base ranking model comprises identifying features that are available within a search index available to the base ranking model but is not considered the base ranking model when returning search results.

4. The method of claim 3, further comprising suggesting different ranking features based on a likelihood that the different ranking feature would positively affect the search results.

5. The method of claim 1, wherein combining the ranking feature with the base ranking model to create a custom search ranking model comprises adjusting a weighting of the ranking feature combined with the base ranking model.

6. The method of claim 1, wherein combining the ranking feature with the base ranking model to create a custom search ranking model comprises automatically tuning the custom search ranking model based on at least a partial evaluation of a set of queries.

7. The method of claim 1, further comprising creating a two-stage ranking model including a first stage and second stage that is a copy of the first stage but includes proximity features, wherein each of the stages are one of: a linear model and a two-layer neural net.

8. The method of claim 1, wherein tuning the custom search ranking model comprises automatically creating a set of queries for evaluation and receiving a number of evaluations that is less than one hundred.

9. The method of claim 1, further comprising displaying an indicator showing a comparison of a performance of the custom search ranking model as compared to the base ranking model without the added ranking feature.

10. A computer-readable medium having computer-executable instructions for configuring a search ranking model, comprising:
determining a base ranking model to use as a primary search ranking model;
determining an evaluation of a set of queries based on results provided by the base model;
determining a ranking feature to add to the base ranking model;
combining the ranking feature with the base ranking model to create a custom search ranking model;
tuning the custom search ranking model; and
storing the custom search ranking model.

11. The computer-readable medium of claim 10, wherein determining the ranking feature to add to the base ranking model comprises identifying features that are available within a search index available to the base ranking model but is not considered the base ranking model when returning search results.

12. The computer-readable medium of claim 10, further comprising suggesting different ranking features based on a likelihood that the different ranking feature would positively affect the search results provided by the base ranking model.

13. The computer-readable medium of claim 10, wherein combining the ranking feature with the base ranking model to create a custom search ranking model comprises adjusting a weighting of the ranking feature combined with the base ranking model.

14. The computer-readable medium of claim 10, wherein combining the ranking feature with the base ranking model to create a custom search ranking model comprises automatically tuning the custom search ranking model based on at least a partial evaluation of a set of queries.

15. The computer-readable medium of claim 10, wherein tuning the custom search ranking model comprises automatically creating a set of queries for evaluation.

16. A system for configuring a search ranking model, comprising:
a network connection that is coupled to tenants of the multi-tenant service;
a processor and a computer-readable medium;
an operating environment stored on the computer-readable medium and executing on the processor; and
a configuration program operating under the control of the operating environment and operative to:
determining a base ranking model to use as a primary search ranking model;
determining an evaluation of a set of queries based on results provided by the base model;
determining a ranking feature to add to the base ranking model;
combining the ranking feature with the base ranking model to create a custom search ranking model;
tuning the custom search ranking model; and
storing the custom search ranking model.

17. The system of claim 16, wherein determining the ranking feature to add to the base ranking model comprises identifying features that are available within a search index available to the base ranking model but is not considered the base ranking model when returning search results.

18. The system of claim 16, further comprising suggesting different ranking features based on a likelihood that the different ranking feature would positively affect the search results provided by the base ranking model.

19. The system of claim 16, wherein combining the ranking feature with the base ranking model to create a custom search ranking model comprises automatically tuning the custom search ranking model based on at least a partial evaluation of a set of queries.

20. The system of claim 16, wherein tuning the custom search ranking model comprises automatically creating a set of queries for evaluation.
